(19) United States
(12) Patent Application Publication
(10) Pub. No.: US 2022/0246015 A1
(43) Pub. Date: Aug. 4, 2022

(54) FALL DETECTION METHOD AND APPARATUS, AND WEARABLE DEVICE

(71) Applicant: Weifang Goertek Microelectronics Co., Ltd., Weifang, Shandong (CN)

(72) Inventors: Dexin Wang, Weifang, Shandong (CN); Susu Di, Weifang, Shandong (CN); Xuejun Zhang, Weifang, Shandong (CN)

(73) Assignee: Weifang Goertek Microelectronics Co. Ltd., Weifang, Shandong (CN)

(21) Appl. No.: 17/610,229

(22) PCT Filed: Dec. 6, 2019
(86) PCT No.: PCT/CN2019/123562

§ 371 Date: Nov. 10, 2021

(30) Foreign Application Priority Data
May 10, 2019 (CN) 201910390405.3

(51) Int. Cl. G08B 21/04

(52) U.S. Cl. CPC G08B 21/0446; G08B 21/043; G08B 21/0492

(57) ABSTRACT

Disclosed are fall detection method and apparatus (400), and a wearable device (100). The method comprising: acquiring air pressure data of a position where a wearable device (100) is located, and performing first fall detection according to the air pressure data to obtain a first detection result (S2100); acquiring an attitude angle of the wearable device in the case that the first detection result is that fall has occurred, and performing second fall detection according to the attitude angle to obtain a second detection result (S2200); and determining a fall detection result according to the first detection result and the second detection result (S2300).

### CROSS-REFERENCE TO RELATED APPLICATIONS

This application is a National Stage of international Application No. PCT/CN2019/123562, filed on Dec. 16, 2019. which claims priority to Chinese Patent Application No. 201910390405.3, filed on May 10, 2019, both of which are hereby incorporated by reference in its entirety.

### TECHNICAL FIELD

The present disclosure relates to the technical field of intelligent electronic devices, and more particularly to a fall detection method, a fall detection device and a wearable device.

### BACKGROUND

In today's society, the aging problem has become increasingly prominent. The elderly people are poor in physical function and are prone to fall in daily life. In the case that an elderly man or woman falls, it would entail serious consequences if he or she is not found in time and helped with appropriate measures. As such, fall detection is of great necessity.

Among existing fall detection methods, those solutions based on single index such as air pressure or acceleration have poor performance in detection accurate rate, and are prone to give false alarm and cannot be applied to some scenes such as in an elevator. For those fall detection solutions based on a plurality of indexes, the power consumption is high and the detection speed is limited since it is necessary to calculate the plurality of indexes.

Therefore, how to propose a more ideal fall detection method has become a problem to be solved.

### SUMMARY

One objective of an embodiment of the present disclosure is to provide a technical solution for fall detection.

According to a first aspect of the present disclosure, a fall detection method is provided, which includes:

acquiring air pressure data of a position where a wearable device is located, and performing first fall detection according to the air pressure data to obtain a first detection result;

acquiring an attitude angle of the wearable device in the case that the first detection result is that fall has occurred, and performing second fall detection according to the attitude angle to obtain a second detection result; and

determining a fall detection result according to the first detection result and the second detection result.

Optionally, the step of performing first fall detection according to the air pressure data includes: acquiring an air pressure variation rate of a position where the wearable device is located according to the air pressure data;

in the case that the air pressure variation rate indicates a tendency to fall, acquiring an air pressure variation of a position where the wearable device is located according to the air pressure data; and

performing first fall detection by comparing the air pressure variation with a set reference variation.

Optionally, the step of acquiring the air pressure variation of the position where the wearable device is located according to the air pressure data includes:

acquiring a first air pressure value of the position where the wearable device is located when the tendency to fall occurs, and acquiring a second air pressure value of the position where the wearable device is located after the tendency to fall has occurred for a period of time; and

determining the air pressure variation according to the first air pressure value and the second air pressure value.

Optionally, the step of acquiring the attitude angle of the wearable device includes: determining a basic attitude angle according to a measurement result of a gyroscope; and

correcting the basic attitude angle according to a measurement result of an accelerometer to obtain the attitude angle of the wearable device.

Optionally, the step of acquiring the air pressure data of the position where the wearable device is located includes:

measuring the air pressure of the position where the wearable device is located according to a set sampling frequency to obtain air pressure original data; and

filtering the air pressure original data to obtain the air pressure data.

Optionally, the method further includes:

sending a first prompt message in the case that the fall detection result is that fall has occurred.

Optionally, the method further includes:

in the case that the fall detection result is that fall has occurred, detecting whether a user has got up after falling according to the air pressure value of the position where the wearable device is located and the attitude angle of the wearable device; and

sending a second prompt message when detecting that the user has not got up.

According to a second aspect of the present disclosure, a fall detection device is provided and includes: a first detection module, a second detection module and a judgment module, wherein the first detection module is configured to acquire air pressure data of a position where the wearable device is located and perform first fall detection according to the air pressure data to obtain a first detection result;

the second detection module is configured to acquire an attitude angle of the wearable device in the case that the first detection result is that fall has occurred and perform second fall detection according to the attitude angle to obtain a second detection result; and

the judgment module is configured to determine a fall detection result according to the first detection result and the second detection result.

According to a third aspect of the present disclosure, a wearable device is provided and includes the fall detection device as defined in the second aspect of the present disclosure; or the wearable device includes:

a memory, configured to store executable commands; and

a processor, configured to perform the method as defined in any one of the first aspect of the present disclosure under control of the executable commands.

The fall detection method provided by the embodiment has the following beneficial effects; fall detection is performed according to the air pressure data of the position where the wearable device is located and the attitude angle of the wearable device, so that higher detection accuracy can be achieved, and false alarm can be reduced. In addition, the attitude angle is not affected by acceleration, height and other factors, so that the fall detection method provided by the embodiment can be suitable for special scenarios, such as when taking an elevator.

The fall detection method provided by the embodiment has the beneficial effects: in this embodiment, the first fall detection is performed based on the air pressure data, and in the case that the first fall detection result is that fall has occurred, the second fall detection is performed based on the attitude angle, so that the power consumption of the fall detection method of the embodiment is significantly reduced. On one hand, the power consumption of acquiring the air pressure data is generally less than the power consumption of acquiring the attitude angle, for example, the power of one air pressure sensor is 10 mW and the power consumption of one gyroscope exceeds 100 mW, so the first fall detection by air pressure has the advantage of power consumption. On the other hand, in this embodiment, acquisition and calculation of the attitude angle are performed under specific conditions and do not need to be performed continuously, further reducing power consumption of the device. In addition, in the falling process, variation of human body height occurs before change of human body posture, so the detection method in this embodiment can capture the fall information at the initial stage of all and facilitates increasing of the detection speed.

### BRIEF DESCRIPTION OF THE DRAWINGS

The accompanying drawings, which are combined in the specification and constitute a part of the specification, describe the embodiments of the present disclosure and, together with the specification, serve to explain the principles of the present disclosure.

FIG. 1 is a schematic diagram of a wearable device for implementing an embodiment of the present disclosure.

FIG. 2 is a flowchart of a fall detection method according to an embodiment of the present disclosure.

FIG. 3 is a schematic diagram of an attitude angle according to an embodiment of the present disclosure.

FIG. 4 is a flowchart of a specific example according to an embodiment of the present

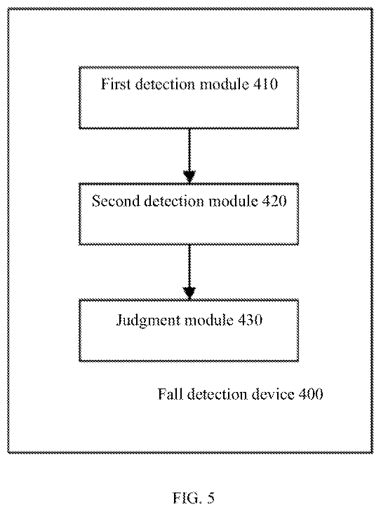

### DISCLOSURE

FIG. 5 is a schematic diagram of a fall detection device according to an embodiment of the present disclosure.

### DETAILED DESCRIPTION OF EMBODIMENTS

Various exemplary embodiments of the present disclosure are described in detail hereinafter with reference to the accompanying drawings. It should be noted that unless otherwise specified, relative arrangement, numerical expressions and values of parts and steps described in the embodiments do not limit the scope of the present disclosure.

The following description of the at least one exemplary embodiment is actually merely illustrative and never constitutes any limitation to the present disclosure and application or use thereof.

Technologies, methods and equipment known to those of ordinary skill in the related art may not be discussed in detail, but, where appropriate, the technologies, methods and equipment should be regarded as a part of the specification.

In all the examples shown and discussed herein, any specific value should be interpreted as merely exemplary rather than restrictive. Therefore, other examples of the exemplary embodiments may have different values.

It should be noted that similar reference numerals and letters represent similar items in the accompanying drawings below. Therefore, once an item is defined in one drawing, it is unnecessary to further discuss the item in the subsequent drawings.

[symbol]

Hardware Configuration

[symbol]

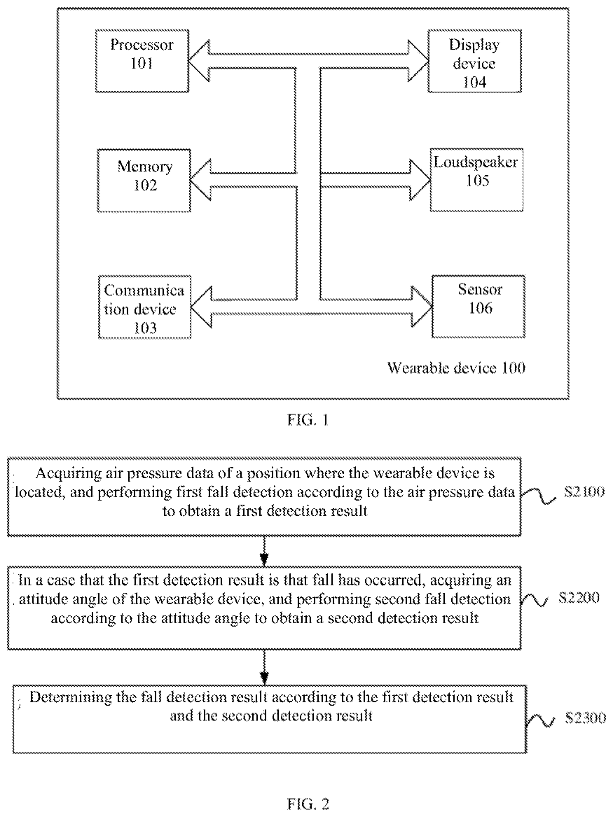

FIG. 1 is a schematic diagram of a wearable device for implementing an embodiment of the present disclosure. As shown in FIG. 1, the wearable device 100 includes a processor 101, a memory 102, a communication device 103, a display device 104, a microphone 105 and a sensor 106.

The processor 101, for example, is a central processing unit (CPU) and a micro control unit (MCU). The memory 102, for example, includes a read only memory (ROM), a random access memory (RAM) and a nonvolatile memory such as a hard disk. The communication device 103, for example, can perform wired communication or wireless communication. The display device 104, for example, may be configured to display text, graphics and other information, for example, may be a liquid crystal display screen. The loudspeaker 105, for example, may be configured to make a prompt tone, for example, it may be an electric microphone, a condenser microphone and a piezoelectric microphone. The sensor 106, for example, is configured to measure a physical quantity, for example, it is an air pressure gauge, a gyroscope, an accelerometer and a magnetometer.

In this embodiment, the sensor 106 at least includes an air pressure gauge, a gyroscope, an accelerometer and a magnetometer, and may be configured to measure the air pressure of the environment where the wearable device is located and the attitude of the wearable device.

The wearable device 100 shown in FIG. 1 is merely illustrative and is not intended to limit the present disclosure and the application or use thereof.

### Embodiment I

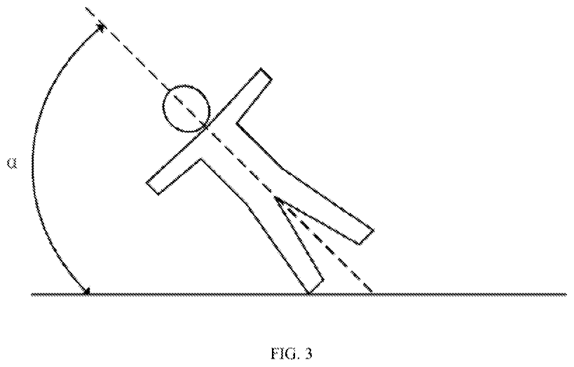

The embodiment provides a fall detection method, which is implemented by, for example, the wearable device in FIG. 1. As shown in FIG. 2, the method includes the following steps S2100-S2300:

step S2100: air pressure data of a position where a wearable device is located is acquired, and first fall detection is performed according to the air pressure data to obtain a first detection result.

In the embodiment, the position of the wearable device relative to the human body is fixed, and variation in height of the gravity center of human body may be reflected by measuring the air pressure of the position where the wearable device is located.

According to the related physical laws, the height of the gravity center will decrease rapidly when people fall. In this embodiment, in consideration of the correlation between the air pressure and the height, the first fall detection is performed based on the air pressure. For example, a height variation rate may be determined from an air pressure variation rate, and a height variation value may be determined from an air pressure variation value. Based on whether the air pressure variation rate and the air pressure variation value are in accordance with the characteristics of falling, it may be judged whether fall has occurred, and thus the first detection result is obtained.

The air pressure may be measured by virtue of an air pressure sensor arranged in the wearable device, for example, a sensor 106 shown in FIG. 1.

Step S2200: an attitude angle of the wearable device is acquired in the case that the first detection result is that fall has occurred, and second fall detection is performed according to the attitude angle to obtain a second detection result.

In this embodiment, first detection is performed according to the air pressure data, and second detection is performed according to the attitude angle in the case that the result of the first detection is that fall has occurred.

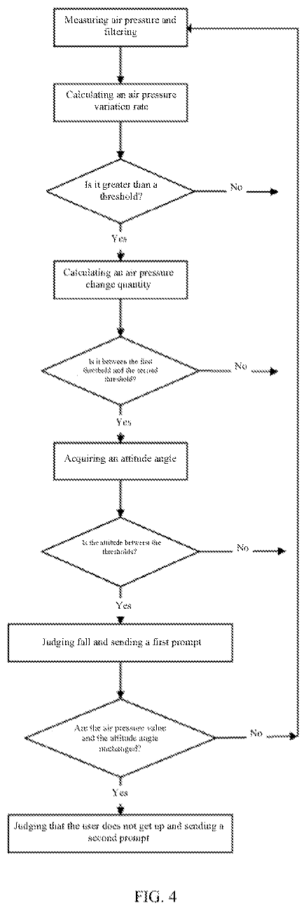

The attitude angle may be, for example, an index for describing a three-dimensional object orientation. As shown in FIG. 3, the attitude angle in the embodiment is an included angle between a symmetry plane of the human body and a horizontal plane, that is, the angle α in FIG. 3. In other embodiments, the attitude angle may be defined in a different way from this embodiment, which is not limited.

Regarding the attitude angle α shown in FIG. 3, the attitude angle α is 90 degrees when a person stands upright, and the attitude angle α is 0 degrees when the person lies on his or her back.

Therefore, the inclination degree of the human body may be determined through the variation of the attitude angle, whether a human has fallen down is detected for the second time to obtain a second detection result.

The attitude angle may be measured by virtue of a gyroscope and an accelerometer provided in the wearable device. In this embodiment, the attitude angle is determined according to the measurement results of both the gyroscope and the accelerometer, so as to obtain higher accuracy.

Step S2300: the fall detection result is determined according to the first detection result and the second detection result.

In this embodiment, the final fall detection result is determined according to the first detection result and the second detection result. The fall detection result is determined as “fall has occurred” only when the first detection result and the second detection result are both “fall has occurred”. For other results, for example, if the first detection result is that “fall has not occurred”, or if the first detection result is that “fall has occurred” and the second detection result is that “fall has not occurred”, it is considered that the final detection result is that “fall has not occurred”.

It should be noted that data processing, logical judgment and other processes in this embodiment are implemented by the wearable device, for example, by the processor 101 in FIG. 1. In other embodiments, the data processing process may also be implemented by other devices other than the wearable device, with the wearable device being used only for parameter measurement and transmission. For example, the wearable device measures the above-mentioned air pressure and attitude angle through its own sensors and sends measurement results to other devices such as a mobile phone through Bluetooth transmission, and the other devices perform data processing according to the received data.

The fall detection method provided by the embodiment has the beneficial effects: fall detection is performed based on the air pressure data of the position where the wearable device is located and the attitude angle of the wearable device, so that higher detection accuracy can be achieved, thus reducing false alarms. In addition, the attitude angle is not affected by acceleration, height and other factors, so that the fall detection method provided by the embodiment can be suitable for special scenarios, such as when taking an elevator.

The fall detection method provided by the embodiment has the beneficial effects: in this embodiment, the first fall detection is performed based on the air pressure data, and in the case that the first fall detection result is that fall has occurred, the second fall detection is performed based on the attitude angle, so that the power consumption of the fall detection method provided by the embodiment can be significantly reduced. On one hand, the power consumption of acquiring the air pressure data is generally less than the power consumption of acquiring the attitude angle, for example, the power of one air pressure sensor is 10 mW and the power consumption of one gyroscope exceeds 100 mW, so the first fall detection by air pressure is advantageous in power consumption. On the other hand, in this embodiment, acquisition and calculation of the attitude angle do not need to be performed continuously and are performed only under specific circumstances, thereby further reducing power consumption of the device.

In addition, during falling, variation of human body height occurs before change of human body posture, and therefore the detection method in this embodiment can sense the fall information at the start of falling, and facilitates increasing of the detection speed.

In a specific implementation of this embodiment, the step of performing first fall detection according to the air pressure data includes: an air pressure variation rate of the position where the wearable device is located according to the air pressure data;

in the case that the air pressure variation rate indicates a tendency to fall, an air pressure variation of the position where the wearable device is located is acquired according to the air pressure data; and first fall detection is performed by comparing the air pressure variation with a set reference variation.

In this example, the tendency to fall is detected according to the air pressure variation rate, and then fall detection is performed according to the air pressure variation in the case that the tendency to fall is detected. In this way, the power consumption of the system can be further reduced; and the detection of the air pressure variation rate may be instantaneous, and the detection of the air variation requires time accumulation. Therefore, the method in the example facilitates further increasing of the detection speed.

In one specific implementation of this embodiment, the step of acquiring the air data of the position where the wearable device is located includes:

the air pressure of the position where the wearable device is located is measured according to a set sampling frequency to obtain air pressure original data; and filtering the air pressure original data to obtain air pressure data.

In this example, the air pressure is measured according to the set sampling frequency to obtain the air pressure original data. For the air pressure original data, data filtering is performed according to a certain rule, for example, a data value with excessive single point variation is removed, so that the subsequent data processing is facilitated, and the detection accuracy is improved.

In one specific implementation of this embodiment, the step of acquiring the air pressure variation of the position where the wearable device is located according to the air pressure data includes:

a first air pressure value of the position where the wearable device is located when the tendency to fall occurs is acquired, and a second air pressure value of the position where the wearable device is located after the tendency to fall occurs after a period of time is acquired; and an air pressure variation is determined according to the first air pressure value and the second air pressure value.

The tendency to fall usually occurs at the start of the falling process. At this moment, the height of people's gravity height does not variate significantly, the position where the wearable device is located at this moment serves as an initial position, and the air pressure value of the position where the wearable device is located at this moment is recorded as a first air pressure value. After the tendency to fall has occurred for a period of time, the height of people's gravity height variates after time accumulation, and the air pressure value of the position where the wearable device is located at this moment is recorded as a second air pressure value. In this way, the air pressure variation rate determined according to the first air pressure value and the second air pressure value can reflect the variation of the height of people's gravity center caused by fall.

In this example, a difference between the air pressure of the current position and the air pressure of the initial position after the tendency to fall occurs for a specific duration may be calculated, and the specific duration, for example, is 1 second. A difference between the air pressure of each current position and the air pressure of the initial position may be calculated in real time after the tendency to fall occurs.

In one specific implementation of this embodiment, the step of acquiring the attitude angle of the wearable device includes:

A basic attitude angle is determined according to a measurement result of a gyroscope; and

The basic attitude angle is corrected according to a measurement result of an accelerometer to obtain the attitude angle of the wearable device.

Since a person is not absolutely stationary within a short period of time after landing, the measurement of the attitude angle will be interfered. In this example, the attitude angle is determined in real time through the gyroscope and is corrected in combination with the measurement result of the accelerometer, so that the attitude angle can be solved accurately.

In one specific implementation of this embodiment, the method further includes: sending a first prompt message when the fall detection result is that fall has occurred.

Means for sending the first prompt message may be for example a loudspeaker of the wearable device sending a prompt tone, may be for example a display device or an indicating lamp of the wearable device sending a prompt signal, and may also be for example sending a short message to a designated communication device and making a call.

By sending a prompt message, it may help the elderly people in asking for help in time.

In one specific implementation of this embodiment, the method further includes: in the case that the fall detection result is that fall has occurred, whether a user has got up after falling is detected according to the air pressure value of the position where the wearable device is located and the attitude angle of the wearable device:

When it is detected that the user has not got up, a second prompt message is sent.

If the user has not got up after falling, the air pressure value of the position where the wearable device is located and the attitude angle of the wearable device will remain in a relatively stable range, and at this moment, then the wearable device sends the second prompt message to remind people that the falling has led to serious results.

### EXAMPLE

FIG. 3 is a flowchart of a specific example of a fall detection method provided by this embodiment.

As shown in FIG. 3, the air pressure is measured according to a set frequency and is filtered, and the air pressure variation rate is calculated in real time and is compared with a corresponding threshold.

Assuming that the variation range of the air pressure value caused by the measurement precision of the device is [m−D,m+D] and the sampling frequency of the device is f when the air pressure is constant (assumed to be m), the air pressure variation rate should not exceed 2Df when people walk horizontally or are still. That is, the threshold of the air pressure variation rate in this example may be set to 2Df, or the threshold is determined with adjustment performed on the basis of the value 2Df by performing a limited number of tests or experiments. It can be seen that the air pressure threshold may be determined according to inherent parameters of the device and in combination with a small number of test results without a large number of data test processes.

When the air pressure variation rate is greater than the threshold 2Df, the air pressure value m0 at this moment is recorded as the initial air pressure, and the variation of the air pressure value relative to m0 is calculated in real time to obtain an air pressure variation. The air pressure variation is compared with the corresponding first threshold and second threshold.

Assuming that the wearing height of the wearable device is H, the increasing quantity of the air pressure is R each time the height is reduced by 1 m, and the attitude angle α after people fall is between 0 degree and 25 degrees, then the air pressure value of the position where the wearable device is located after people fall is between HXRX(1−sin25°) and HXR, that is, in this example, the first threshold of the air pressure variation is HXRX(1−sin25°) and the second threshold is HXR.

When the air pressure variation is between HXRX(1−sin25°) and HXR, the attitude angle α of the wearable device at this moment is measured, and whether the attitude angle α is between the corresponding attitude angle thresholds is compared.

Based on the above assumption, the thresholds of the attitude in the example are 0° and 25° respectively.

When the attitude angle of the wearable device is between the thresholds 0° and 25° it may be judged that fall has occurred, and a first prompt is sent at this moment.

Then, a judgment is made as to whether the air pressure value and the attitude angle have changed. In this process, it is necessary to consider the measurement error of the device.

When it is judged that both the air pressure value and the attitude angle are unchanged, it is judged that a user has not got up after falling, then a second prompt is sent.

### Embodiment I

This embodiment provides a fall detection device. As shown in FIG. 3, the fall detection device 400 includes a first detection module 410, a second detection module 420 and a judgment module 430,

wherein the first detection module 410 is configured to acquire air pressure data of a position where the wearable device is located and perform first fall detection according to the air pressure data to obtain a first detection result;

the second detection module 420 is configured to acquire an attitude angle of the wearable device in the case that the first detection result is that fall has occurred and perform second fall detection according to the attitude angle to obtain a second detection result; and the judgment module 430 is configured to determine a fall detection result according the first detection result and second detection result.

The specific function of each module may be referenced to the description of the fall detection method in the embodiment I, which will not be elaborated herein.

In one specific implementation of the embodiment I, the first detection module 410 is further configured to: acquire an air pressure variation rate of a position where the wearable device is located according to air pressure data; acquire an air pressure variation of the position where the wearable device is located is acquired according to the air pressure data; and perform first fall detection by comparing the air pressure variation with a set reference variation.

In one specific implementation of the embodiment I, the first detection module 410 is further configured to: acquire a first air pressure value of the position where the wearable device is located when a tendency to fall occurs, and acquire a second air pressure value of the position where the wearable device is located after the tendency to fall has occurred for a period of time; and determine an air pressure variation according to the first air pressure value and the second air pressure value.

In one specific implementation of the embodiment I the first detection module 410 is further configured to: measure the air pressure of the position where the wearable device is located according to a set sampling frequency to obtain air pressure original data; and filter the air pressure original data to obtain air pressure data.

In one specific implementation of the embodiment I, the fall detection device further includes an attitude measurement module (not shown in the figure). The attitude measurement module is configured to: determine a basic attitude angle according to a measurement result of a gyroscope; and correct the attitude angle according to a measurement result of an accelerometer to obtain the attitude angle of the wearable device.

In one specific implementation of the embodiment I, the fall detection device further includes a prompt module (not shown in the figure). The prompt module is configured to: send a first prompt message in the case that the fall detection result is that fall has occurred.

In one specific implementation of the embodiment I, the prompt module is further configured to: in the case that the fall detection result is that fall has occurred, detect whether a user has got up after falling according to the pressure value of the position where the wearable device is located and the attitude angle of the wearable device; and send a second prompt message when detecting that the user has not got up.

### Embodiment III

This embodiment provides a wearable device, including the fall detection device according to the embodiment II. Or

the wearable device includes:

a memory, configured to store an executable commands; and

a processor, configured to perform the method as defined in any one of methods in the embodiment I under control of the executable commands.

The present disclosure may be a system, a method and/or a computer program product. The computer program product may include a computer readable storage medium, which carries computer readable program instructions for enabling a processor to implement various aspects of the present disclosure.

The computer readable storage medium may be a tangible device which may maintain and store instructions used by an instruction executing device. The computer readable storage medium, for example, may be, but not limited to, an electric storage device, a magnetic storage device, an optical storage device, an electromagnetic storage device, a semiconductor storage device or any suitable combination of the above. A more specific example (a non-exhaustive list) of the computer readable storage medium includes: a portable computer disk, a hard disk, a random access memory (RAM), a read only memory (ROM), an erasable programmable read only memory (EPROM or flash), a static random access memory (SRAM), a portable compact disk read only memory (CD-ROM), a digital versatile disc (DVD), a memory stick, a soft disk, a mechanical coding device, such as a punched card in which an instruction is stored or a protruded structure in a groove, and any suitable combination of the above. The computer readable storage medium used herein is not explained as an instantaneous signal itself, such as radio waves or other freely propagating electromagnetic waves, electromagnetic waves propagated through waveguide or other transmission mediums (sch as light pulse through an optical fiber cable), or an electric signal transmitted through wires.

The computer readable program instruction described herein may be downloaded to various computing/processing devices from the computer readable storage medium, or may be downloaded to an external computer or an external storage device through networks such as Internet, a local area network, a wide area network or a wireless network. The network may include copper transmission cables, optical fiber transmission, wireless transmission, routers, firewalls, switches, gateway computers and/or edge servers. A network adapter card or network interface in each computing/processing device receives the computer readable program instruction from the network and forwards the computer readable program instruction to be stored in the computer readable storage medium in each computing/processing device.

The computer program instruction for performing the operation of the present disclosure may be an assembly instruction, an instruction set architecture (ISA) instruction, a machine instruction, a machine related instruction, a microcode, status setting data, or a source code or a target code written in any combination of one or more programming languages, wherein the programming languages include object-oriented programming languages such as Smalltalk and C++, and conventional procedural programming languages such as “C” language or similar programming languages. The computer readable program instruction may be completely executed on a user computer, be partially executed on the user computer, be executed as an independent software package, be partially executed on the user computer and partially executed by a remote computer, or be completely executed on the remote computer or a server. In the situation involving the remote computer, the remote computer may be connected to the user computer through any types of networks, including a local area network (LAN) or a wide area network (WAN), or may be connected to an external computer (for example, connected through the Internet by an Internet service provider). In some embodiments, an electronic circuit is subjected to personalized customization by using the status information of the computer readable program instruction, such as a programmable logic circuit, a field programmable gate array (FPGA) or a programmable logic array (PLA); and the electronic circuit may execute the computer readable program instruction so as to implement various aspects of the present disclosure.

Various aspects of the present disclosure are described herein with reference to flowcharts and/or block diagrams according to the method, the device (system) and the computer program product. It should be understood that each block of the flowcharts and/or the block diagrams, and the combination of the blocks in the flowcharts and/or block diagrams may be implemented by the computer readable program instruction.

These computer readable program instructions may be provided for a general-purpose computer, a dedicated computer, or a processor of any other programmable data processing device to generate a machine, so that the instructions, when being executed by a computer or a processor of any other programmable data processing device, generate a device for implementing a function/action specified in one or more blocks in the flowcharts and/or the block diagrams. These computer readable program instructions may be stored in the computer readable storage medium. These instructions enable the computer, the programmable data processing device and/or other devices to work in a specific manner, so that the computer readable medium storing the instruction includes one product, including the instructions that implement various aspects of the function/action specified in one or more blocks of the flowcharts and/or the block diagrams.

These computer program instructions may also be loaded onto a computer, other programmable data processing devices or other devices, so that a series of operation steps are performed on the computer, other programmable devices or other devices, thereby generating a computer-implemented process. Therefore, the instructions executed on the computer, other programmable devices or other devices implement the function/action specified in one or more blocks in the flowcharts and/or the block diagrams.

The flowcharts and the block diagrams in the accompanying drawings show implementable system architectures, functions and operation for systems, methods and computer program products according to various embodiments of the present disclosure. At this point, each block in the flowcharts or the block diagrams may represent a module, a program segment or one part of an instruction, wherein the module, the program segment or one part of the instruction includes one or more executable instructions for implementing specified logical functions. In some alternative implementations, the functions noted in the blocks may also occur in a different order from those noted in the drawings. For example, two continuous blocks actually may be executed in substantially parallel, and sometimes they may be executed in a reverse order, depending on the functions involved. It should also be noted that, each block in the block diagrams and/or the flowcharts as well as combination of blocks in the block diagrams and/or flowcharts may be implemented by a special system which executes the specified function or action based on hardware, or may be implemented by combination of special hardware and computer instructions. It is well known to those skilled in the art that implementation through hardware, implementation through software and implementation through combination of software and hardware are all equivalent.

The above descriptions of the embodiments of the present disclosure are illustrative, not exhaustive, and not limited to the disclosed embodiments. It is apparent to those skilled in the art that various modifications and changes may be made without departing from the scope and spirit of the described embodiments. The selection of terms used in the specification is intended to best explain the principle of each embodiment, actual application or technical improvement in the market, or each embodiment which can be understood by other ordinary technicians in the technical field and is disclosed herein. The scope of the present disclosure is defined by the appended claims.

1. A fall detection method for a subject with a wearable device, comprising:
acquiring air pressure data of a position where a wearable device is located, and performing a first fall detection according to the air pressure data to obtain a first detection result:
acquiring an attitude angle of the wearable device if the first detection result is that a fall has occurred, and performing a second fall detection according to the attitude angle to obtain a second detection result; and
determining a fall detection result according to the first detection result and the second detection result.

2. The method of claim 1, wherein the performing the first fall detection comprises:
acquiring an air pressure variation rate of a position where the wearable device is located according to the air pressure data;
if the air pressure variation rate indicates a tendency to fall, acquiring an air pressure variation of a position where the wearable device is located according to the air pressure data; and
performing the first fall detection by comparing the air pressure variation with a set reference variation.

3. The method of claim 2, wherein the . . . acquiring the air pressure variation rate comprises:
acquiring a first air pressure value of the position where the wearable device is located when the tendency to fall occurs, acquiring a second air pressure value of the position where the wearable device is located after the tendency to fall has occurred for a period of time; and
determining the air pressure variation according to the first air pressure value and the second air pressure value.

4. The method of claim 1, wherein the acquiring the attitude angle of the wearable device comprises:
determining a basic attitude angle according to a measurement result of a gyroscope; and
correcting the basic attitude angle according to a measurement result of an accelerometer to obtain the attitude angle of the wearable device.

5. The method of claim 1, wherein the acquiring the air pressure data comprises:
measuring the air pressure of the position where the wearable device is located according to a set sampling frequency to obtain air pressure original data; and
filtering the air pressure original data to obtain the air pressure data.

6. The method of claim 1, further comprising:
sending a first prompt message if the fall detection result is that fall has occurred.

7. The method of claim 6, further comprising:
if the fall detection result is that fall has occurred, detecting whether a user has got up after falling according to the air pressure value of the position where the wearable device is located and the attitude angle of the wearable device; and
sending a second prompt message when detecting that the user has not got up.

8. A fall detection device for a subject with a wearable device, comprising a first detection module, a second detection module and a judgment module, wherein
the first detection module is configured to acquire air pressure data of a position where the wearable device is located and perform first fall detection according to the air pressure data to obtain a first detection result;
the second detection module is configured to acquire an attitude angle of the wearable device in the case that the first detection result is that fall has occurred and perform second fall detection according to the attitude angle to obtain a second detection result; and
the judgment module is configured to determine a fall detection result according to the first detection result and the second detection result.

9. A wearable device comprising the fall detection device of claim 8.

10. A wearable device comprising:
a memory, configured to store executable commands; and
a processor, configured to perform the method of claim 1 under control of the executable commands.
